(19) United States
(12) Patent Application Publication
(10) Pub. No.: US 2012/0211411 A1
(43) Pub. Date: Aug. 23, 2012

(54) Extended Area Filter

(75) Inventor: Sam A. Hopkins, Belews Creek, NC (US)

(73) Assignee: PUROLATOR FACET, INC., Greensboro, NC (US)

(21) Appl. No.: 13/031,342

(22) Filed: Feb. 21, 2011

(51) Int. Cl. B01D 29/11; B01D 29/52; B01D 39/10

(52) U.S. Cl. 210/333.01; 210/487; 210/347

(57) ABSTRACT

An extended area filter is provided. The extended area filter has sheets of a filter media configured for increased filter media surface area. A plurality of filter media tubes are position in a concentric arrangement about a longitudinal axis of the filter, defining annular inlet volumes and annular outlet volumes, the annular inlet volumes receiving an unfiltered fluid, and the outlet volumes receiving a filtrate passed through the tubes of filter media. A filter apparatus configured for filtering a contaminated fluid and employing extended area filters of the invention is also provided.

### FIELD OF THE INVENTION

This invention generally relates to filters. More specifically, this invention relates to filter baskets.

### BACKGROUND OF THE INVENTION

Filter baskets are used in housings in a variety of applications, and in a large number of industries. Filter baskets may be employed in several configurations, including non-backwashing, backwashing, and pre-coat resin arrangements.

Housings with filter baskets have a long history of use in industrial markets. Applications where these types of filters are used has grown to include environments where the standard disposable non-woven polymer filter bags are not acceptable or cost-effective. Reusable metal filter baskets are used instead of disposable filter baskets for a variety of reasons such as temperature, characteristics of the fluid being filtered, economy, and ability to clean the filter basket in place through backwashing.

A standard metallic filter basket has similar dimensions to a nonwoven basket. Since a metal filter media typically does not hold as much contaminant as non-woven polymer filter bags, there have been attempts to compensate for the differences in dirt hold capacity between non-woven depth media and surface filter metallic media by increasing the area of metallic media in a given filter basket envelope. A typical method used for increasing the surface area of metallic media filter baskets is the use of tube bundles. Although utilizing tube bundles can increase the media surface area when compared to the standard single-tube metallic filter basket design, there are still applications were the metallic filter baskets need to be improved to reduce pressure drop, reduce flux rate across the filter media, and/or reduce system down time and reduce backwashing waste by increasing the time interval between filter basket change-out or backwashing.

Additionally, there is a need to reduce the foot print or volume occupied by filter systems when large and/or multiple filter housings are necessary to meet a minimum filter area requirement, and a need for a filter basket that can hold more contaminants than currently available filter baskets.

The invention provides such a filter and method by providing more filter media area in the same filter element envelop as currently existing products. These and other advantages of the invention, as well as additional inventive features, will be apparent from the description of the invention provided herein.

### BRIEF SUMMARY OF THE INVENTION

In one aspect, the invention provides a filter having sheets of metal filter media surrounding a longitudinal axis. The filter has inlet and outlet faces at opposite axial ends of the filter, and each filter media sheet extends between the filter inlet and outlet faces. Inlet passages are formed between the sheets of metal filter media, where each inlet passage is open to the inlet face and closed to the outlet face, and has a length extending generally in the direction of the longitudinal axis. Outlet passages are also formed between the sheets of metal filter media, where each outlet passage is open to the outlet face and closed to the inlet face, and has a length extending generally in the direction of the longitudinal axis. A flow path from the inlet face to the outlet face passes through at least one of the sheets of filter media.

In another aspect, the invention provides an extended area filter. The extended area filter comprises a first tubular sheet of metal filter media surrounding a longitudinally extending axis between opposed first and second end faces of the filter, where the first and second end faces are at opposite axial ends of the filter with one of the faces being an inlet face and the other an outlet face. A second tubular sheet of metal filter media is telescopically interfit within the first tubular sheet of filter media, a third tubular sheet of metal filter media is telescopically interfit within the second tubular sheet of filter media, and a fourth tubular sheet of metal filter media is telescopically interfit within the third tubular sheet of filter media. A first annular closure is provided between ends of the first and second tubular sheet proximate the first end face; a second annular closure is provided between ends of the second and third tubular sheet proximate the second end face; and a third annular closure is provided between ends of third and fourth tubular sheet proximate the first end face. First annular flow passages extend generally in the direction of the longitudinal axis, and are formed between the first and second tubular sheets and between the third and fourth tubular sheets, such that the first annular flow passages are open to the second flow face and are closed to the first flow face. A second annular flow passage extends generally in the direction of the longitudinal axis, and is formed between the second and third tubular sheets, such that the second annular flow passage is open to the first flow face and closed to the second flow face. A flow path from the inlet face to the outlet face passes through at least one of the tubular sheets of metal filter media.

In yet another aspect, the invention provides a filter apparatus comprising a housing, with an interior volume divided into an inlet plenum and an outlet plenum. The housing also comprises a filter holder separating the inlet plenum and outlet plenum. A filter is mounted in the filter holder. The filter comprises a longitudinal axis, an inlet and outlet faces at opposite axial ends of the filter. The filter inlet face is in fluid communication with the inlet plenum, and the filter outlet face is in fluid communication with the outlet plenum. The filter further comprises filter media tubes concentrically arranged about the longitudinal axis such that each filter media tube extends between the inlet and outlet faces of the filter. The filter tubes are configured to form a plurality of inlet passages between the plurality of filter tubes, such that each inlet passage is open to fluid flow at the inlet face and closed to fluid flow at the outlet face, and has a length extending generally in the direction of the longitudinal axis. A fluid flow path from the housing inlet plenum to the housing outlet plenum passes through at least one of the sheets of filter media.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a first exemplary embodiment of an extended area filter;

FIG. 2 is another perspective view of the filter of FIG. 1;

FIG. 3 is a perspective cross-sectional view of the filter of FIG. 1;

FIG. 4 is a perspective view of a second exemplary embodiment of an extended area filter;

FIG. 5 is another perspective view of the filter of FIG. 3;

FIG. 6 is a perspective cross-sectional view of the filter of FIG. 3;

FIG. 6A is a detail cross-sectional view of the filter of FIG. 3;

FIG. 6B is a detail cross-sectional view of the filter of FIG. 3;

FIG. 6C is a detail cross-sectional view of an exemplary embodiment of the filter media of the filter of FIG. 3;

FIG. 6D is a detail cross-sectional view of a configuration of the end of filter tubes of the filter of FIG. 3;

FIG. 6E is a detail cross-sectional view of an alternate configuration of the end of filter tubes of the filter of FIG. 3;

FIG. 6F is a detail cross-sectional view of an alternate configuration of the end of filter tubes of the filter of FIG. 3;

FIG. 6G is a detail cross-sectional view of an alternate configuration of the end of filter tubes of the filter of FIG. 3;

FIG. 7 is a perspective view of a tubular sheet of filter media configured for use with extended area filters of the present invention;

FIG. 8 is a partial cut-away view of a filtration apparatus suitable for use with extended area filters of the present invention;

FIG. 9 is a cross-sectional view of an in-line filtration apparatus suitable for use with extended area filters of the present invention; and

FIG. 10 is a cross-sectional view of a cross-flow filtration apparatus suitable for use with extended area filters of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

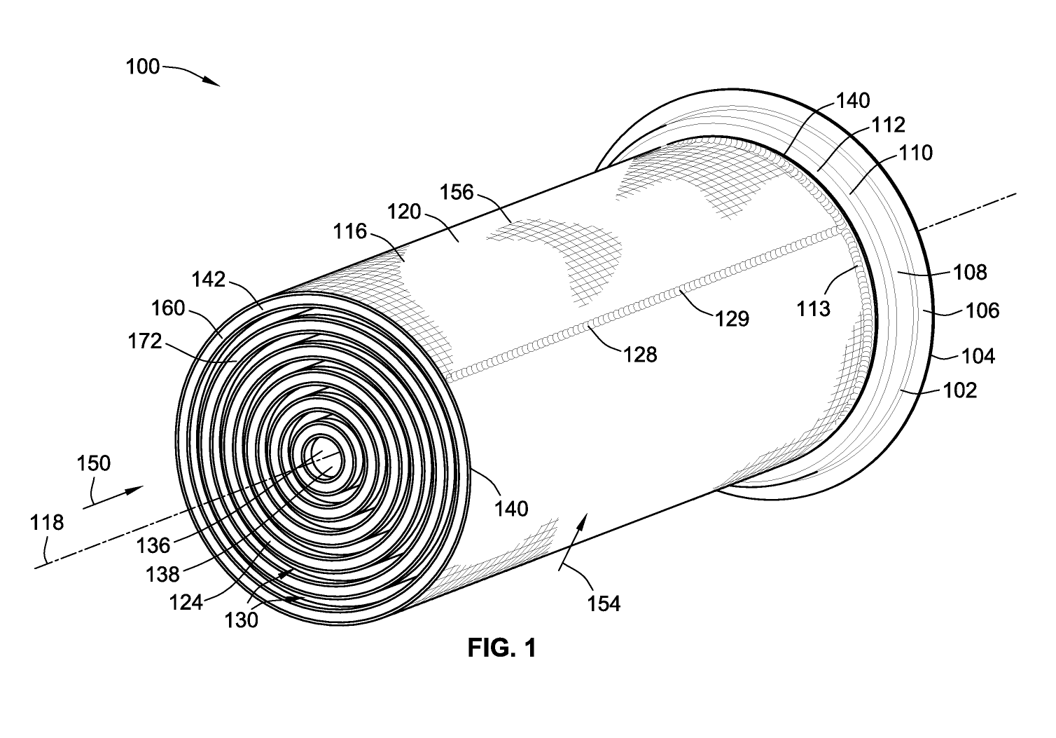

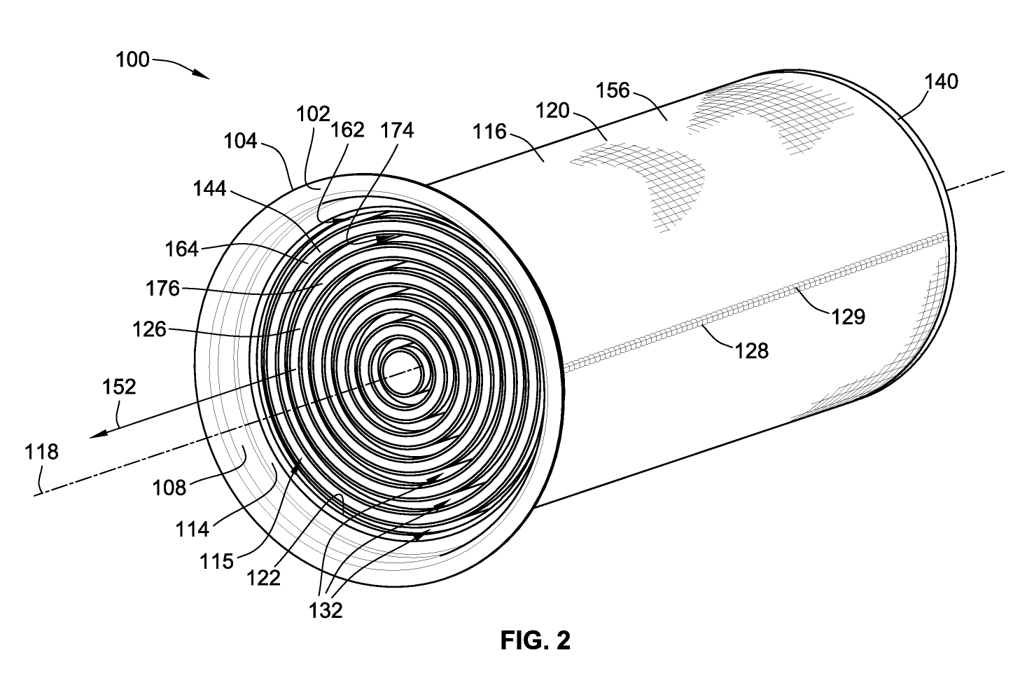

Referring to FIGS. 1-2, a first exemplary embodiment of an extended area filter is shown configured as an extended area filter basket 100 having an end ring 102, an inlet face 124, an outlet face 126, and a plurality of sheets of a metal filter media 116 that may be configured as filter tubes 116 or otherwise wrapped to extend between the inlet face 124 and the outlet face 126. Inlet face 124 of filter 100 and outlet face 126 of filter 100 are generally planar and perpendicular to the longitudinal axis 118 of filter 100, and are disposed at opposite axial ends of filter 100. In other embodiments, the axial lengths of filter tubes 116 may differ, such that inlet face 124 and/or outlet face are non-planar (generally conical, parabolic, etc.).

As can be seen in the drawings, a plurality of filter tubes 116 are arranged to provide a lot of metal filter media within a compact volume area. In the embodiment shown, filter tubes 116 are generally cylindrical (including a cylinder shaped or tapered/cone shaped), and are concentrically disposed about the longitudinal axis 118 of filter 100. In other embodiments, filter tubes 116 may be other shapes, e.g. elliptical or polygonal with straight sides (“annular” and “tubular” as used herein are meant to be generic to include generally cylindrical and these other shape possibilities). In preferred embodiments, sheets of filter media 116 have a preferential flow direction for fluid filtration, and sheets of filter media are oriented such that filter fluids flow from a flow-in surface 120 of filter 100 to a flow-out surface 122 of filter 100. Concentric sheets of filter media 116, in conjunction with inlet spacer rings 142 and outlet spacer rings 144 that provide for annular closures, define alternating annular cylindrical volumes that provide inlet and outlet flow passages, shown as unfiltered fluid receiving volumes 130 or inlet flow volumes 130, and filtrate receiving volumes 132 or outlet flow volumes 132. Inlet flow volumes 130 are open at inlet flow face 124 and are sealingly closed at outlet face 126, and are in fluid communication with the flow-in surfaces 120 of filter tubes 116. Outlet flow volumes 132 are open at outlet flow face 126 and are sealingly closed at inlet face 124, and are in fluid communication with the flow-out surfaces 120 of filter tubes 116. It is understood that inlet and outlet flow volumes are reversible and depend upon how the filter is used in application (e.g. if flow is reversed, the inlet flow volumes become outlet flow volumes and vice versa).

To provide for mounting and/or sealing of the filter, a mounting ring that may take the form of a weld-compatible metal end ring 102 may be provided. End ring 102 of filter 100 includes a circumferential flange 104, a sealing surface 106 of flange 104, an annular wall 108, a screen mounting surface 112, and a filter media attachment flange 114. Filter media attachment flange 114 defines an end ring annulus 115 for receiving the outlet face 126 of filter 100. A chamfer 110 may be provided between cylindrical wall 108 of end ring 102 and screen mounting surface 112 of end ring 102. Alternatively, chamfer 110 of end ring 102 may be a rounded exterior corner or a sharp corner. In other embodiments, annular wall 108 may be a tapered, or frustoconical, wall which may be interpositioned between flange 104 of end ring 102 and screen mounting surface 112 of end ring 102. In still other embodiments, sheets of filter media may be joined directly to a annular wall 108 of end ring 108, without a separate filter media attachment flange 114. End ring 102 may optionally be provided with one or more support structures (rod, flat bar, perforated plate, etc.) configured to support the plurality of filter media tubes at the outlet face 126 of filter 100 or the inlet face 124 of filter 100, thereby constraining movement of the filter tubes 116 of filter 100 in both radial and axial directions.

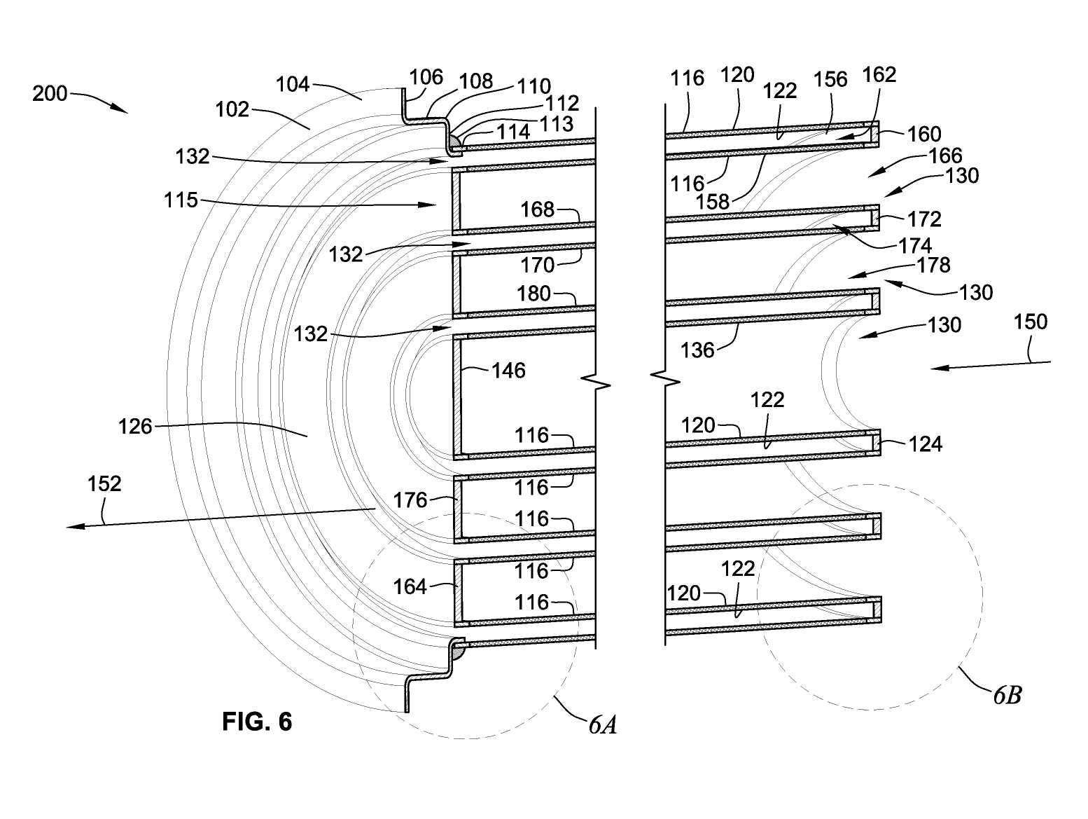

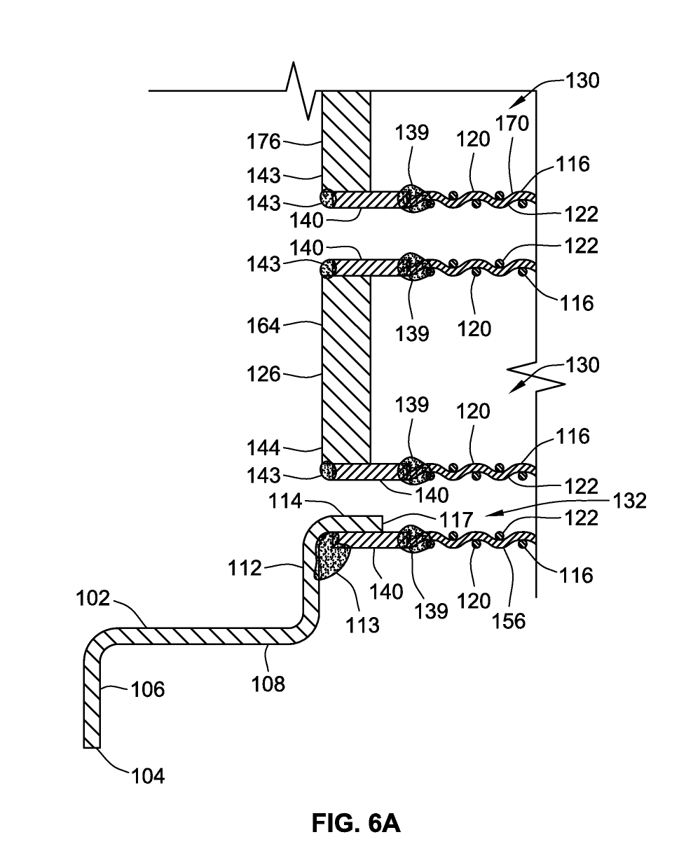

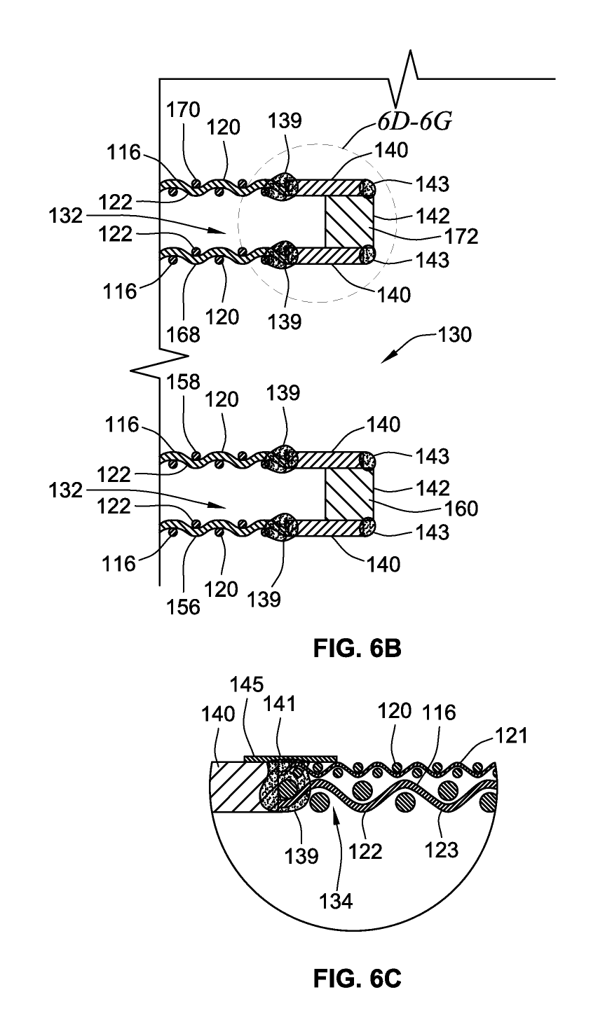

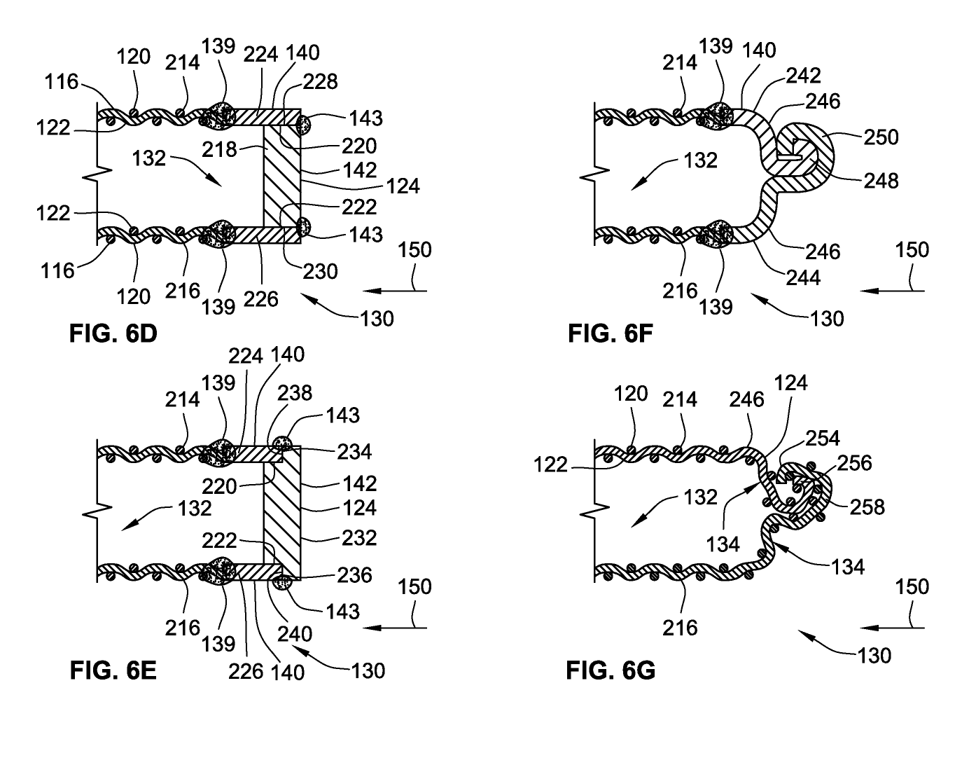

In a typical embodiment, tubes of metal filter media 116 may include a longitudinal seam 128. In a preferred embodiment, longitudinal seam 128 is a welded seam providing additional structural support for tubes of filter media 116. In the embodiments shown, filter tubes 116 are formed and welded without the use of a safe edge material incorporated in longitudinal seam 128 and longitudinal weld 129. However, longitudinal seam 128 and longitudinal weld 129 may optionally include one or a pair of safe edges 140 (discussed in more detail with reference to FIGS. 6A-6C below). Also, the longitudinal seam in some embodiments may be formed by crimping opposed longitudinal ends together.

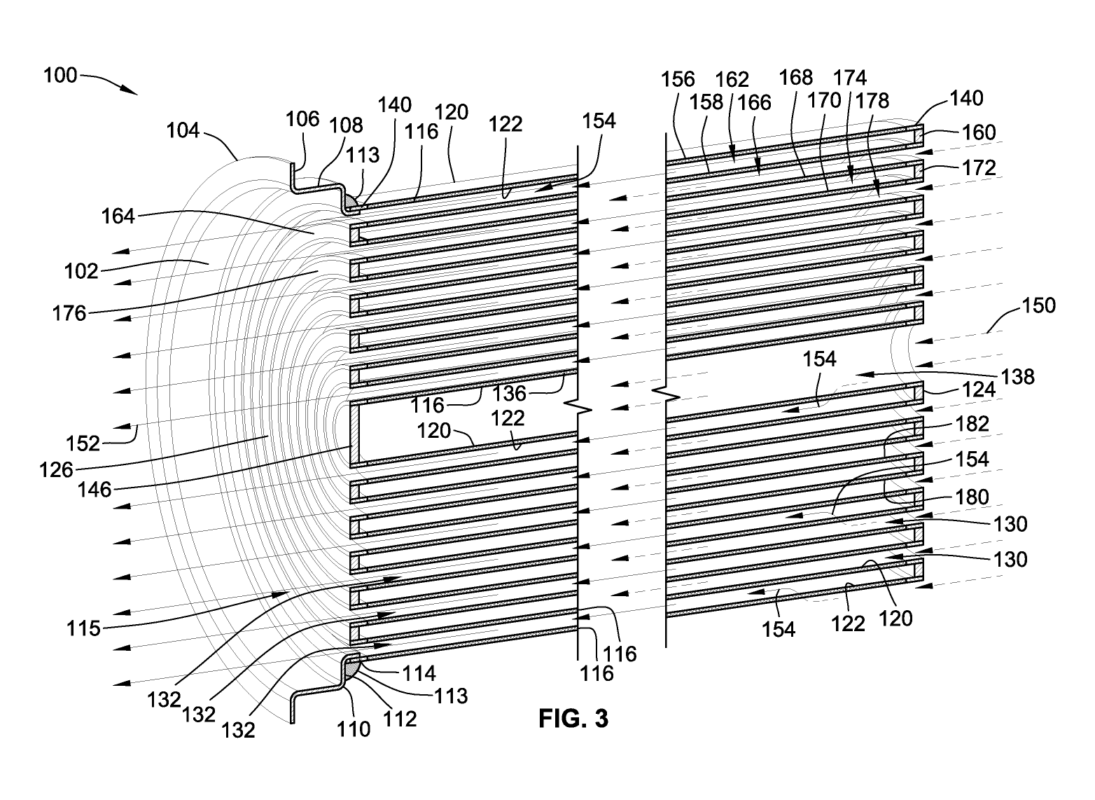

Referring to FIG. 3, a cross-sectional view showing the internal structure of an extended area filter is shown. A filter media tube 116 is positioned as a first filter media tube 156 in a cylindrical configuration on the outer periphery of filter 100, and substantially parallel to the longitudinal axis 118 of filter 100. First filter media tube 156 is joined to filter media attachment flange 114 of end ring 102 by an annular welded seam 113. In a preferred embodiment, first filter media tube 156 is provided with a safe edge 140 at the inlet face 124 and/or the outlet face 126 to facilitate welding of filter tube 156 to other elements of filter 100. The safe edge 140 can be a strip of metal material.

In the exemplary embodiment shown in FIGS. 1-3, inlet spacer rings 142 and outlet spacer rings 144 have substantially similar radial thicknesses, thereby supporting adjacent filter media tubes 116 (for example, filter tube 156, 158) at a constant radial distance from each other. In some embodiments, however, outlet spacer rings 144 may have a greater radial thickness or a lesser radial thickness than inlet spacer rings 142.

A second filter media tube 116 is positioned as a second filter media tube 158, telescoped within first filter media tube 156 and substantially parallel to longitudinal axis 118. An appropriately sized inlet face spacer ring 142, shown as first inlet spacer ring 160, is interpositioned between first filter media tube 156 and the second filter media tube 158, adjacent to inlet face 124 of filter 100. The ends of the first filter media tube 156 and the second filter media tube 158 are sealing joined to first inlet spacer ring 160 at the ends of tubes 156, 158 adjacent to inlet face 124.

First and second filter tubes 156, 158 and first inlet spacer ring 160 thereby define a first flow-out volume 162, the first flow-out volume 162 being an annular cylinder closed to fluid flow at the end adjacent to inlet face 124 and open to fluid flow at the end adjacent to outlet face 126. First inlet spacer ring 160 thereby blocks the flow of the fluid being filtered from passing directly from the inlet face 124 and inlet volumes 130 to the outlet face 126 and the outlet volumes 132 without passing through a filter media.

A third filter media tube 116 is positioned as a third filter media tube 168, telescoped within second filter media tube 158 and substantially parallel to longitudinal axis 118. An appropriately sized outlet face spacer ring 144, shown as first outlet spacer ring 164, is interpositioned between second filter media tube 158 and the third filter media tube 168, adjacent to outlet face 126 of filter 100. The ends of the second and third filter media tubes 158, 168 adjacent to outlet face 126 are sealingly joined to first outlet spacer ring 164.

Second and third filter tubes 158, 168 and first outlet spacer ring 164 thereby define a first flow-in volume 166, the first flow-in volume 166 being an annular cylinder open to fluid flow at the end adjacent to inlet face 124 and closed to fluid flow at the end adjacent to outlet face 126. First outlet spacer ring 164 thereby blocks the flow of the fluid being filtered from passing directly from the inlet face 124 and inlet volumes 130 to the outlet face 126 and the outlet volumes 132 without passing through a filter media.

A fourth filter media tube 116 is positioned as a fourth filter media tube 170, telescoped within third filter media tube 168 and substantially parallel to longitudinal axis 118. An appropriately sized inlet face spacer ring 142, shown as second inlet spacer ring 172, is interpositioned between third filter media tube 168 and the fourth filter media tube 170, adjacent to inlet face 124 of filter 100. The ends of the third filter media tube 168 and the fourth filter media tube 170 are sealingly joined to second inlet spacer ring 172 at the ends of filter tubes 168, 170 adjacent to inlet face 124.

Third and fourth filter tubes 168, 170 and second inlet spacer ring 172 thereby define a second flow-out volume 174, the second filtrate volume 174 being an annular cylinder closed to fluid flow at the end adjacent to inlet face 124 and open to fluid flow at the end adjacent to outlet face 126. Second inlet spacer ring 172 thereby blocks the flow of the fluid being filtered from passing directly from the inlet face 124 and inlet volumes 130 to the outlet face 126 and the outlet volumes 132 without passing through a filter media. It should be noted that first, second, third and fourth are used for differentiation purposes only, rather than a specific location or arrangement.

Still referring to FIG. 3, additional filter tubes 116 may be concentrically positioned within filter tubes 156, 158, 168, and 170 and joined with alternating inlet face spacer rings 142 and outlet face spacer rings 144 in the same manner as disclosed above, thereby defining alternating inlet flow volumes 130 and outlet flow volumes 132. The innermost concentric filter tube 116 (i.e., the tube having the smallest diameter), shown as center tube 136, is sealed at the end adjacent to outlet face 126 by an end cap 146, thereby allowing fluid to be exposed to the flow-in surface 120 center tube 136 while blocking the fluid flow from passing directly from the inlet face 124 and inlet volumes 130 to the outlet face 126 and the outlet volumes 132 without passing through a filter media.

In a preferred embodiment of an extended area filter, inlet spacer rings 142 and outlet spacer rings 144 are formed from a stainless steel material and are impermeable to fluid flow. In other embodiments, spacer rings 142, 144 may be formed from a permeable material, thereby adding additional filtration capacity to the extended area filter. Such closures can thereby either be permeable or provide sealed ends. In the embodiments shown, filter media tubes 116 are sealingly joined to spacer rings 142, 144 by welding, e.g. gas tungsten arc welding. In other embodiments, spacer rings 142, 144 may be another material, such as a plastic, epoxy, or elastomer, and may be joined to filter tubes 116 by thermal welding, an adhesive compound (epoxies, cements, self-setting agents, etc.), or mechanical fastening (rolled seam, fasteners, etc.). In yet other embodiments, filter media tubes 116 may be tapered or frustoconical with respect to radial distance from longitudinal axis 118, such that the alternating ends of the filter tubes may be directly joined (welded, adhered, potted, mechanically fastened, etc.) without interpositioned spacer rings 142, 144. All of the foregoing can effectively provide closures between edges of sheets.

As shown in FIG. 3, a fluid to be filtered flows in inlet flow direction 150 into inlet flow volumes 130 and around the outer diameter of first filter tube 156, and thereby into contact with flow-in surfaces 120 of the sheets of filter media 116. The fluid flows through the sheets of filter media 116, as shown by flow paths 154, and out through flow-out surfaces 122, thereby passing into outlet flow volumes 132 and out of the filter 100 in the direction of outlet flow 152. As will be readily appreciated by those skilled in the art, the extended area filters disclosed herein may also be used in filtration application where backwashing (i.e., flow from axial flow face 126 to axial flow face 124) is periodically used to remove particulate matter from the filter media. To facilitate the same, surface loading media (in contrast to depth loading media) such as wire mesh with well defined pore sizes can be used. Fibrous metal media may be used in some embodiments but those that trap particulates and do not readily release would not be used for backwashing applications.

In other applications, configuration of a primary direction opposite to the described flow direction (i.e. a flow direction from axial flow face 126 to axial flow face 124, and in a direction opposite to flow directions 150, 152) may be desirable. In filters employing layered filter media, it may be advantageous to orient the sheets of filter media 116 such that the layers are oriented to provide optimal filtration when fluid is filtered in the primary flow direction.

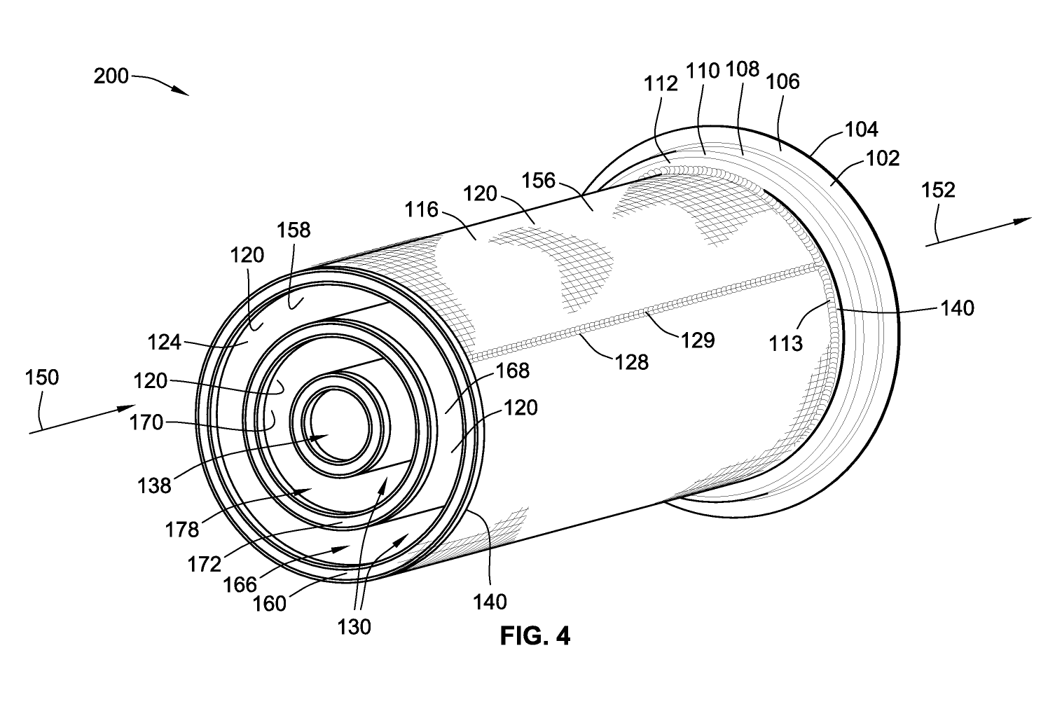

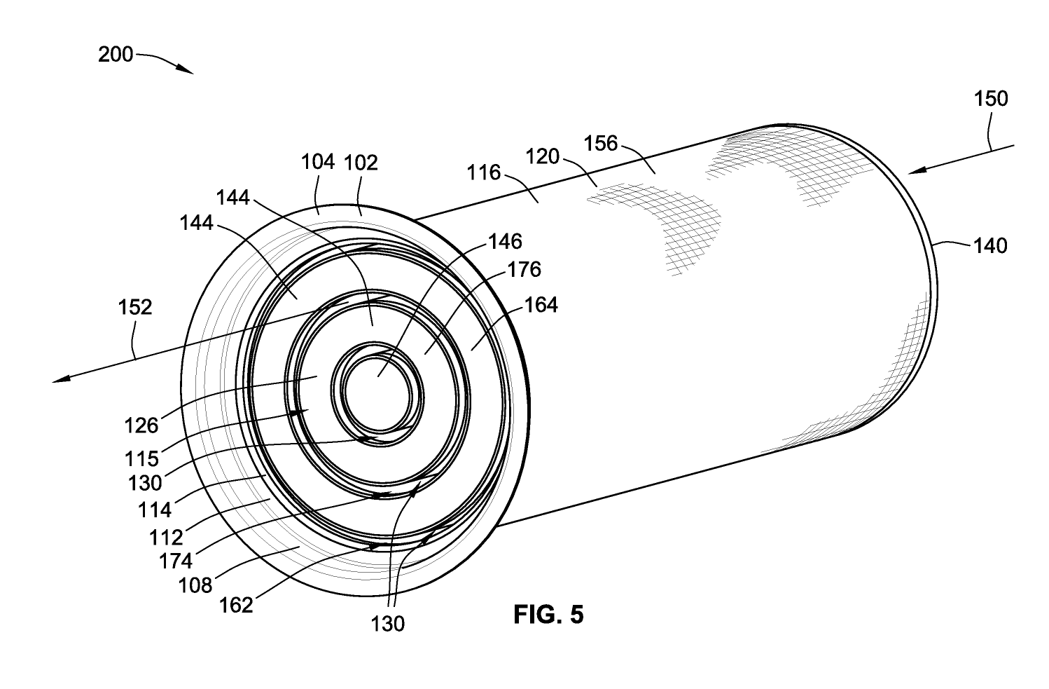

Referring to FIGS. 4-6, a second embodiment of an extended area filter is shown as filter basket 200, where like number refer to like elements. Filter 200 is configured for pre-coat resin filter applications, wherein a fluid containing a pre-coat resin is passed through the filter housing containing the filter basket 200. To accommodate pre-coat resin filter applications, filter 200 is typically provided with a radial distance of at least about 0.75 inches between the flow-in surfaces 120 of filter tubes 116 (i.e., between filter tubes 158 and 168, and between filter tubes 170 and 180). In such applications, the radial thickness of inlet spacer rings 142 may be less than the radial thickness of outlet spacer rings 144. After the filter basket is coated with the resin, a contaminated fluid is passed through the filter housing containing the resin coated filter basket. Typically, the pre-coat resin is either a catalyst or a filter enhancing medium such as diatomaceous earth, which is accumulated on the flow-in surfaces 120 of filter 200 prior to filtration of a contaminated fluid. The contaminated fluid is thereby filtered through both the resin coat and the sheets of filter media 116, enhancing the particulate filtration provided by extended area filter basket 200. In other applications, flow-in surfaces of a filter 200 may be separated by less than 0.5 inches, about 0.5 inches, about 1 inch, or greater than 1 inch.

Referring to FIGS. 6A, 6B, and 6C, detail views of filter media are shown. In embodiments where sheets of filter media 116 are a metal mesh screen or another metal filter media, the edges of the sheets of filter media 116 may be a provided with a safe edge 140, as disclosed in U.S. Pat. No. 6,514,408, which is hereby incorporated by reference in its entirety. Safe edge 140 is a strip or band of metal that is welded or otherwise joined (e.g. sintered, rolled seam, adhesive, etc.) to the edges of sheets of metal filter media 116. A weld material 139 joins the safe edge 140 and the filter media 116, thereby sealing pores proximate to the safe edge 140 and preventing leaking if the welding process produced any distortions of the filter media 116. Preferably, safe edge 140 is a metal that is compatible with the welding metal used in the weld joint, such that the metal strip of safe edge 140 becomes unitary with the weld joint 139 between the material of safe edge 140 and the sheet of filter media 116.

In a preferred embodiment, a safe edge 140 is butt welded to layers 121 and 123 of a filter media 116, such that safe edge 140 extends in a longitudinal direction from the sheets of filter media of filter tubes 116, and such that weld joint 139 joins and seals safe edge 140 to both finer mesh layer 121 and coarser mesh layer 123. In the embodiments shown using a metal screen filter media, safe edge 140 is used at the ends of the tubes to facilitate joining of the sheets of filter media 116 to inlet spacer rings 142, outlet spacer rings 144, an end cap 146, and filter media attachment flange 114 of end ring 102.

Referring to FIG. 6A, a detail view of the outlet face 126 and end ring 102 of filter 200 is shown. Each filter tube 116 is joined by a welded seam 139 to a safe edge 140 extending longitudinally from the filter tube 116. Safe edge 140 of first filter tube 156 is joined to media attachment flange 114 of end ring 102 by welded seam 113 extending circumferentially around media attachment flange 114 of end ring 102. As shown, safe edge 140 of first filter tube 156 is joined at the outside diameter of media attachment flange 114. In other embodiments, safe edge 140 of first filter tube 156 may be joined at the inside diameter of media attachment flange 114, or may be longitudinally joined to the axial face 117 of media attachment flange 114 of end ring 102.

Safe edges 140 of second and third filter tubes 158, 168 are joined by welded seams 143 to an outlet spacer ring 144, shown as spacer ring 164. As shown in FIGS. 6D-6G, various configurations for attachment of inlet and outlet spacer rings 142, 144 are within the scope of the present invention. Additional outlet spacer rings 144, including outlet spacer ring 176, are similarly joined, by welding or another method, to additional filter tubes 116 concentrically positioned inside filter tubes 156, 158, and 168.

Referring to FIG. 6B, a detail view of the inlet face 124 of filter 200 is shown. Each filter tube 116 is joined by a welded seam 139 to a safe edge 140 extending longitudinally from the filter tube 116. Safe edges 140 of first and second filter tubes 156, 158 are joined by welded seams 143 to an inlet spacer rings 142, shown as inlet spacer ring 160. As shown in FIGS. 6D-6G, various configurations for attachment of inlet and outlet spacer rings 142, 144 are within the scope of the present invention. Additional outlet spacer rings 144, including outlet spacer ring 176, are similarly joined, by welding or another method, to additional filter tubes 116 concentrically positioned inside filter tubes 156, 158, and 168.

Referring to FIG. 6C, a detail view of preferred embodiment of sheets of filter media 116 having two layers of filter media is shown. In the embodiments shown, a preferred filter media 116 is a diffusion bonded sintered laminate filter media, typically comprising a stainless steel material or another non-ferrous material. Sheets of filter media 116 may be comprised of multiple layers of metal screen, each of which itself is surface loading (and hence can be used for backwash applications). As shown, the layers include a finer mesh 121 and a coarser mesh 123. In preferred embodiments, finer mesh 121 may have a mesh size ranging from 1 micron to about 200 micron. In other embodiments, the mesh size of finer mesh 121 may be smaller than 1 micron or larger than 200 microns. The mesh size of coarser mesh 123 is preferably larger than the mesh size of finer mesh 121. Finer mesh 121 is typically sintered to coarser mesh 123, which thereby provides structural support for finer mesh 121 against forces exerted on filter tubes 116 in radial and/or axial directions.

In a preferred embodiment, the filter media is a five layer filter media including a guard mesh at flow-in surface 120, a fine filter mesh 121, and coarse support meshes 122 at flow-out surface 120. Exemplary five-layer filter material is commercially available from Purolator Facet, Inc. 8439 Triad Drive, Greensboro, N.C., and is sold under the trademark POROPLATE®. In such a multi-layer embodiment, the fine layer 121 of filter media 116 is positioned in fluid communication with flow-in surface 120 of filter 100, and the coarse layer 123 of filter media 116 is positioned in fluid communication with flow-out surface 122 of filter 100. In other embodiments employing two or more layers of filter media, a coarser layer 123 may be positioned in fluid communication with flow-in surface 120 of filter 100, and a finer layer 121 may be positioned in fluid communication with flow-out surface 122 of filter 100

Other exemplary filter materials are sold under the trademarks POROMESH® and POROFELT®, which are also both commercially available from Purolator Facet, Inc. POROMESH® is a woven wire mesh similar to POROPLATE® media, that has not been diffusion bonded. POROFELT® media is a fiber-metal felt media typically having a pore size ranging from about 3 microns to about 80 microns. However, fiber-metal felt media may have a pore size less than 3 microns or greater than 80 microns.

Alternatively, sheets of filter media 116 may have a single layer, or may include three or more layers. Other embodiments of extended area filters may advantageously utilize any other porous medium, including but not limited to wire mesh (woven, welded or otherwise), fiber-metal felt (used with or without wire mesh), sintered powder, wire wrap, perforated sheet, wedge wire, sintered wire depth media (as disclosed in U.S. Pat. No. 7,497,257, which is hereby incorporated by reference in its entirety), and polymer (woven and non-woven) filter mediums.

A wire screen or woven wire mesh provides surface filtration, i.e., the screen or mesh prevents particles of the desired size and larger from passing through the screen and all filtered particles are trapped on or near the top surface of the screen. Wire screens for use with extended area filters include screens ranging from a standard mesh size 500 (25.0 microns) to a standard mesh size 4 (5,156 microns). Wire screen having a mesh size smaller than 25 microns or larger than 5,156 microns may also be employed with extended area filter baskets.

Wire wrap is also a common type of surface filtration. Wire wrap is a usually triangular-shaped wire that is wrapped around a supporting structure, with a given gap between wires to accomplish a particle filtration size. One difficulty with surface filtration is that as larger particles are captured on the filter layer, the open spaces become smaller and smaller, thus capturing smaller and smaller particles. Eventually the particles being captured are so fine that the filter becomes plugged, severely reducing or stopping flow of filtrate through the screen. Accordingly, extended area filters may be configured for backwashing to clear accumulated particulate matter from the sheets of filter 116 as necessary.

Other embodiments of extended area filters may employ perforated sheet media having a preferred pore size of between about 250 microns and 1000 microns. However, perforated sheet media may have a pore size smaller than 250 microns or larger than 1000 microns.

Still referring to FIG. 6C, sheets of filter media 116 may be provided with a sealing strip 141 overlapping the flow-in surface 120 of filter tube 116. Sealing strip 141 covers the pores 134 in the screen 121 proximate to another metal structure to which it is welded, such as safe edge 140. Prior to welding, the sealing strip 141 may be bent around the screen if desired, or may lie flat along the top or bottom surface of the screen. In another embodiment, a sealing strip 141 may be positioned covering the pores 134 of flow-out surface 122 of sheet of filter media 116. Addition of a sealing strip 141 to the sheets of filter media 116 may thereby reduce formation of gaps larger than the pore size of the filter media, and/or provide additional structural stiffness to the sheets of filter media 116. In another embodiment, the non-overlapping portion 145 of a sealing strip 141 may be directly welded or otherwise joined to spacer rings 142, 144 and/or end cap 146, thereby allowing spacer rings to seat against non-overlapping portion 145 of sealing strip 141 and a weld 139 joined to sealing strip 141.

Referring to FIGS. 6D-6G, detail views of alternate annular closures for end configurations for filter tubes 116 are shown with respect to inlet face 124 of a filter basket, for example filter basket 200. Inlet face 124 and flow-in surfaces 120 receive a flow of a permeate fluid, shown generally by flow direction 150. As will be readily apparent to those of skill in the art, similar end configurations for filter tubes 116 (including spacer rings 144 and end cap 146 attached thereto) may be employed at outlet face 126 of filters of the present invention, in any combination.

FIG. 6D shows an annular closure in the form of inlet spacer ring 142 as an annular ring 218 having an inner radial face 220 and an outer radial face 222. In a preferred embodiment, annular rings for use as spacer rings 142 (and similarly for use as outlet spacer rings 144 and end cap 146, not shown) are cut from a flat steel plate, for example using a water jet cutter. Filter media tubes 116 are shown as first and second filter media tubes 214, 216, having a first safe edge 224 and second safe edge 226 respectively. First safe edge 224 has a outer radial wall 228, and second safe edge 226 has an inner radial wall 230. Inlet spacer ring 142 is positioned between outer radial wall 228 of first safe edge 224 of first filter tube 214, and inner radial wall 230 of second safe edge 226 of second filter tube 216, such that inner radial face 220 of spacer ring 142 contacts outer radial wall 228 of first safe edge 224 of first filter tube 214, and outer radial face 222 of spacer ring 142 contacts inner radial wall 230 of second safe edge 226 of second filter tube 216. First safe edge 224 and second safe edge 226 are each welded at weld joint 143, or otherwise joined, to inlet spacer ring 142, thereby sealing outlet flow volume 132 from inlet flow volume 130.

FIG. 6E shows an annular closure in the form of inlet spacer ring 142 as an annular ring 232 having an inner radial face 220, an outer radial face 222, an inner axial race 234, and an outer axial race 236. Inner axial race 234 is configured to seat on longitudinal face 238 of first safe edge 224 of first filter tube 214, and outer axial race 236 is configured to seat on longitudinal face 240 of second safe edge 226 of second filter tube 216. First safe edge 224 and second safe edge 226 are each welded at weld joints 143, or otherwise joined, to inlet spacer ring 142, thereby sealing outlet flow volume 132 from inlet flow volume 130.

FIG. 6F shows an alternate annular closure end configuration for filter tubes 116 wherein spacer rings 142 that provide the closures are not required, but instead other forms of closures are used. Annular closures may be extended safe edges 140, shown as first extended safe edge 242 and second extended safe edge 244, are joined to filter tubes 214, 216 respectively. First and second extended safe edges 242, 244 are swaged or otherwise provided with a radial shoulder 246, bringing ends 248, 250 of extended safe edges 242, 244 into an adjacent relation. Ends 248, 250 of extended safe edges 242, 244 are then rolled to form a rolled seam 252. Alternatively, ends 248, 250 of extended safe edges 242, 244 may be joined by any other means known in the art, such as welding, adhesives, epoxy potting, crimping, mechanical fasteners, etc., thereby sealing outlet flow volume 132 from inlet flow volume 130.

FIG. 6G shows another alternate annular closure end configuration for filter tubes 116 wherein spacer rings 142 are not required. Ends 254, 256 of first and second filter tubes 214, 216 respectively are swaged or otherwise provided with a radial shoulder 246, bringing ends 254, 256 into an adjacent relation. Ends 254, 256 of filter tubes 214, 216 are then rolled to form a rolled seam 258. Alternatively, ends 254, 256 of filter tubes 214, 216 may be joined by any other means known in the art, such as welding, adhesives, epoxy potting, crimping, mechanical fasteners, etc., thereby sealing outlet flow volume 132 from inlet flow volume 130. Optionally, open pores 134 of filter tubes 214, 216 proximate to radial shoulders 246, ends 254, 256, and rolled seam 258 may be coated or sealed to reduce or eliminate fluid communication between outlet flow volume 132 and inlet flow volumes 130 that may have been distorted or widened during the swaging, rolling, or other manipulation of ends 254, 256 of filter tubes 214, 216 respectively.

As shown in FIGS. 1-3, extended area filter 100 includes 12 concentric filter tubes 116. In the embodiment shown in FIGS. 4-6, extended area filter 200 includes 6 concentric filter tubes 116. As may be readily appreciated, other embodiments of extended area filters may include any number of filter tubes 116, as appropriate for the dimensions of the filter, spacing between the filter tubes, and the characteristics of the fluid to be filtered. Specifically, extended area filters embodying the disclosed invention may include 2 filter tubes, 4 tubes, 8 tubes, 10 tubes, 14-20 tubes, or more. In embodiments wherein end cap 146 is positioned at outlet face 126, as shown in FIGS. 3 and 6, the number of filter tubes will generally be even. In embodiments where an end cap is instead positioned at the inlet face 124, the number of filter tubes may be increased or decreased by one as compared to embodiments wherein end cap 146 is positioned at outlet face 126.

Although this invention can apply to any filter basket size and is not limited to any industry standard filter basket configuration, the example figures show the typical advantage and area improvement of this invention for a size 2 filter basket. In a standard configuration of a size #2 filter, i.e., a filter basket having a single cylinder of a filter media disposed about a longitudinal axis, and having a diameter of about 6.56 inches and a length of about 29.5 inches, the convention filter basket provides a filter media surface area of about 4.23 square feet. In the exemplary embodiment shown in FIGS. 1-3, extended area filter basket 100 is configured in the same size envelope as the standard size #2 filter, wherein the media length of filter tubes 116 along the longitudinal axis 118 of filter 100 is about 29.5 inches, the first filter tube 156 of filter 100 has an outer diameter of about 6.56 inches, and spacer rings 142, 144 provide a spacing of about 0.188 inches between adjacent filter tubes 116, thereby providing a total filter media area of filter 100 of approximately 28.5 square feet. In the exemplary embodiment shown in FIGS. 4-6, having the same exterior dimensions, filter basket 200 provides a total filter media surface area of about 15.1 square feet. In other configurations, an extended area filter configured as a size #2 filter may provide a total filter media area of greater than 5 square feet, 10-20 square feet, 20-25 square feet, 25-30 square feet, or greater than 30 square feet.

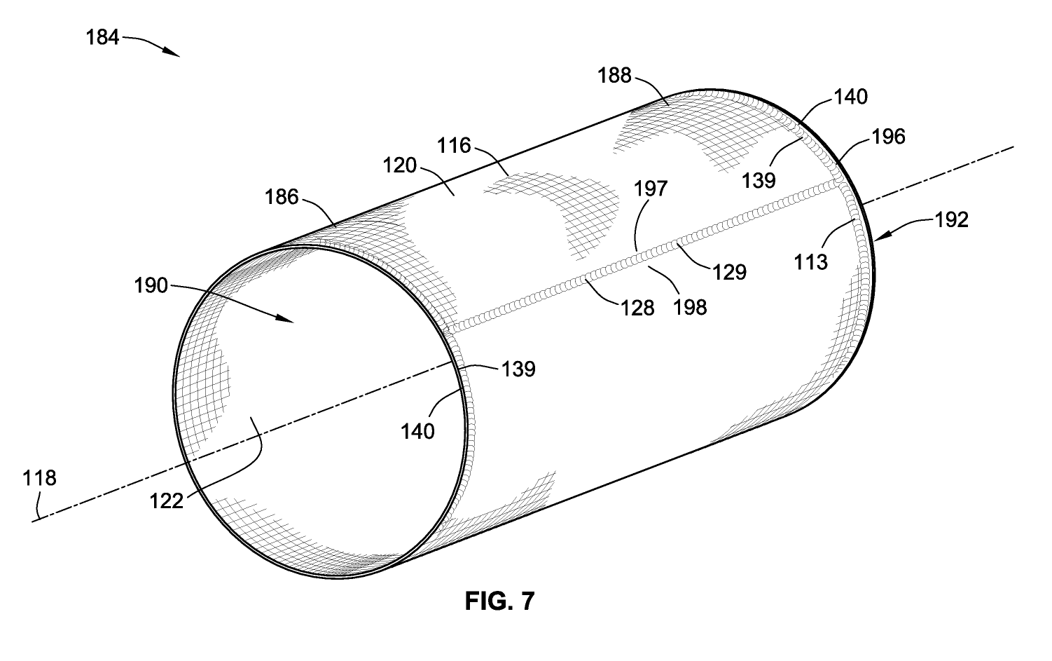

Referring to FIG. 7, a single sheet of filter media 116 is shown as a filter tube 184 having a longitudinal axis 118, a first end 186, a second end 188, and seam edges 197, 198. First end 186 defines an opening 190, and second end 188 defines a second opening 192. Filter tube 184 is provided with a safe edge 140, shown as first safe edge 194 at the first end 186 of filter tube 184. Filter tube 184 is further provided with a safe edge 140, shown as second safe edge 196 at the second end 188 of filter tube 184.

In a preferred embodiment, filter tube 184 is formed from a planar sheet of filter media 116, such as a sheet of sintered laminate filter media. Strips of safe edge material 140 are added to the first and second ends of the filter media sheet to aid in welding the filter tube 184 to, for example, spacer rings 142, 144 and/or media attachment flange 114 during assembly. A flat strip (shown best as strip 141 in FIG. 6C) may also be added to safe edge 140 and sheets of filter media while the sheet 116 is a planar sheet. After the safe edge is added, if required, the filter media sheet is sheared to the final forming size corresponding to the developed axial length and radial circumference for the filter tube 184 being formed. The planar sheet is then formed into a tubular shape, with the “flow-in” surface 120 of the media on the inside or outside diameter, depending on design criteria. The filter tube 184 is then completed with a seam weld 129, or other joining method, being made along the longitudinal seam 128, thereby joining the edges 197, 198 of the formed filter media sheet.

Additional filter tubes of appropriate diameters are telescoped inside one another with appropriately sized spacer rings being inserted between the filter tubes 116. The ends of the tubes are then welded, or otherwise joined, to the spacer rings, forming a seal between the “flow-in” sides of the filter tubes and the “flow-out” sides of the filter tubes. Welding, or other joining method, is done on all tube ends and spacer rings, sealing the “flow-in” side of the filter tube assembly from the “flow-out” side. An end ring 102 is welded, or otherwise joined, to the filter tube assembly, completing the assembly of a filter basket, e.g. filter basket 100. Different styles of end ring 102 may be utilized depending on the size, configuration, and shape of the filter basket housing. Each end ring 102 is configured to mate with and form a seal between the flow-in surfaces 120 and flow-out surfaces 122 of the filter basket for a particular housing.

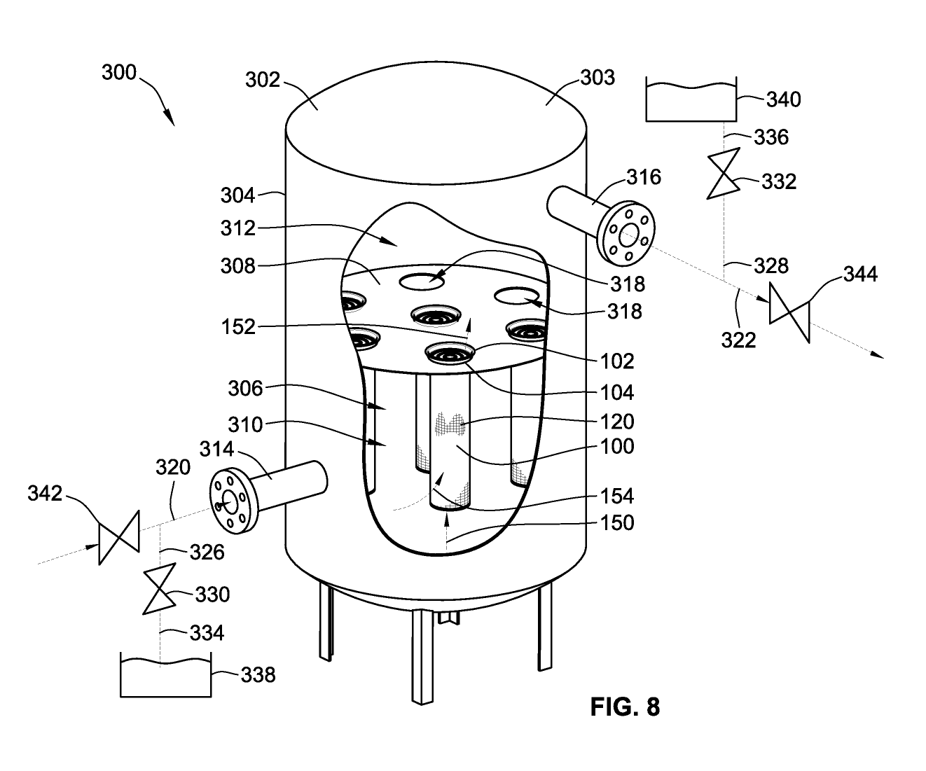

Referring to FIG. 8, one or more filters 100 may be installed in a filtration apparatus 300, shown as an exemplary filtration vessel 302. Filtration vessel 302 is shown having a removable top 303, an outer wall 304, the outer wall 304 defining an interior volume 306. Filtration vessel 302 also includes a basket holder 308 disposed within filtration vessel 302 and dividing interior volume 306 of filtration vessel 302 into an inlet plenum 310 of filtration vessel 302 and an outlet plenum 312 of filtration vessel 302. Filtration vessel 302 further includes at least one fluid inlet 314 in fluid communication with inlet plenum 310 of filtration vessel 302, and at least one fluid outlet 316 in fluid communication with outlet plenum 312 of filtration vessel 302. Removable top 303 may be any structure or selectively closeable opening (flanged cover, lid, hatch, etc.) providing access to outlet plenum 312, thereby permitting removal, cleaning, and/or replacement of filters 100 as necessary for efficient operation of filtration apparatus 300. Additionally, outer wall 304 of filtration vessel 302 may optionally be provided with an outlet or drain valve in fluid communication with inlet plenum 310, permitting the removal of accumulated particulate matter from inlet plenum 310 of filtration vessel 302 without requiring disassembly of filtration vessel 302 for cleaning.

One or more annular openings 318 are provided in basket holder 308 for receiving a filter basket, shown as an expanded area filter basket 100. Annular opening 318 is configured to receive annular wall of end ring 102 of filter 100 such that inlet face 124 of filter 100 is in fluid communication with inlet plenum 310, and outlet face 126 of filter 100 is in fluid communication with outlet plenum 312 of filtration vessel 302. When a filter 100 is installed in annular opening 318 of basket holder 308, flange 104 of filter 100 forms a fluid-impermeable seal between end ring 102 of filter 100 and basket holder 308, thereby preventing fluid communication between inlet plenum 310 of filtration vessel 302 and outlet plenum 312 of filtration vessel 302. Sealing surface 106 of end ring 102 may optionally be provided with an annular closure material (e.g., O-ring, fiber washer, gasket, etc.) providing a face seal between basket holder 308 of filtration vessel 302 and sealing surface 106 of end ring 102 of filter 100. Alternatively, an annular closure material may be provided on basket holder 308 circumferentially surrounding annular opening 318.

An exemplary schematic backwashing system suitable for filtration vessels of the present invention is also shown in FIG. 8. A fluid intake pipe 320 is provided in fluid communication with inlet plenum 310, a permeate valve 342, and a pipe 326 and a backwash waste valve 330. A filtrate outflow 322 is provided in fluid communication with outlet plenum 312, a pipe 328 and backwash fluid supply valve 332, and a filtrate outlet valve 344. Backwash waste valve 330 is in fluid communication with a pipe 334 and backwash waste vessel 338, and backwash fluid supply valve 332 is in fluid communication with a pipe 336 and a backwash fluid reservoir 340. In other embodiments, backwashing of filter baskets may be accomplished by reversing the flow fluid, for example by pressurizing outlet plenum 312 to a pressure higher than inlet plenum 310, thereby forcing a previously filtered fluid through filters 100 in a direction from the outlet flow faces to the inlet flow faces and opposite to flow direction 150.

During filtering operation of filtration apparatus 300, valves 342, 344 are open and back-wash valves 330, 332 are closed. A contaminated fluid is flowed from inlet valve 342 through fluid intake 320 and fluid inlet 314 to inlet plenum 310, and filtered by passing through filters 100 to outlet plenum 312. The clean filtrate then flows out of the outlet plenum 312 through fluid outlet 316 and filtrate outflow 322 to filtrate outlet valve 344. To backwash filter baskets 100, fluid intake and outflow valves 342, 344 are closed and valves 330, 332 are opened. A backwash cleaning fluid is then flowed from backwash fluid reservoir 340 to outlet plenum 312, through filters 100 (in a reverse direction from normal flow) to inlet plenum 310, thereby removing trapped particulate matter from the flow-in surfaces 120 of filters 100. The resulting contaminated backwash fluid is then passed from inlet plenum 310 to backwash waste vessel 338 for appropriate disposal. Once backwashing is complete, valves 330, 332 are closed and valves 342, 344 are opened, allowing filtering from inlet plenum 310 to outlet plenum 312 through filters 100 to resume.

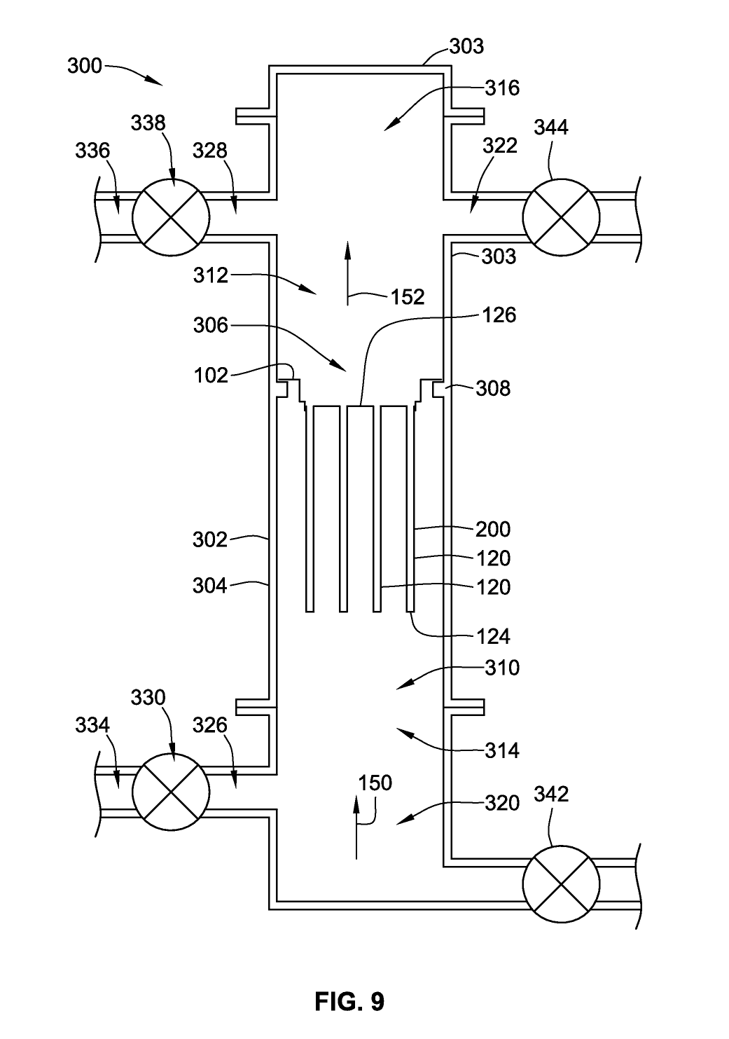

FIG. 9 shows a second exemplary embodiment of a filtration apparatus 300 configured for in-line filtration, where like numbers refer to like elements. Filtration apparatus 300 is shown with a filter vessel 302 configured to house a single filter basket, such as a filter basket 200. In some embodiments of an in-line filtration vessel, an extended area filter may be employed for down-hole filtration, i.e. in a well or borehole. Outer wall 304 is provided with a filter holder 308 size to sealingly receive an end ring 102 of a filter basket 200. A flow of contaminated fluid 150 is received in inlet plenum 310 and filtered through filter basket 200. The filtrate is received from filter basket 200 in outlet plenum 312, and exits the filtration vessel through outflow 322 and filtrate outlet valve 344. Removable top 303 may be any structure or selectively closeable opening (flanged cover lid, hatch, etc.) providing selective access to outlet plenum 312, thereby permitting removal, cleaning, and/or replacement of filter baskets (for example, filters 100 or 200) as necessary for efficient operation of filtration apparatus 300.

A filtration apparatus 300 configured for in-line filtration may also be provided with a backflow system for cleaning extended area filters installed therein, shown as a fluid intake pipe 320 provided in fluid communication with inlet plenum 310, a permeate supply valve 342, and a pipe 326 and a backwash waste valve 330, and additionally a filtrate outflow 322 provided in fluid communication with outlet plenum 312, a pipe 328 and backwash fluid supply valve 338, and a filtrate outlet valve 344. Backwash waste valve 330 is in fluid communication with a pipe 334 receiving backwash waste, and backwash fluid supply valve 332 is in fluid communication with a pipe 336 providing a backwash fluid supply.

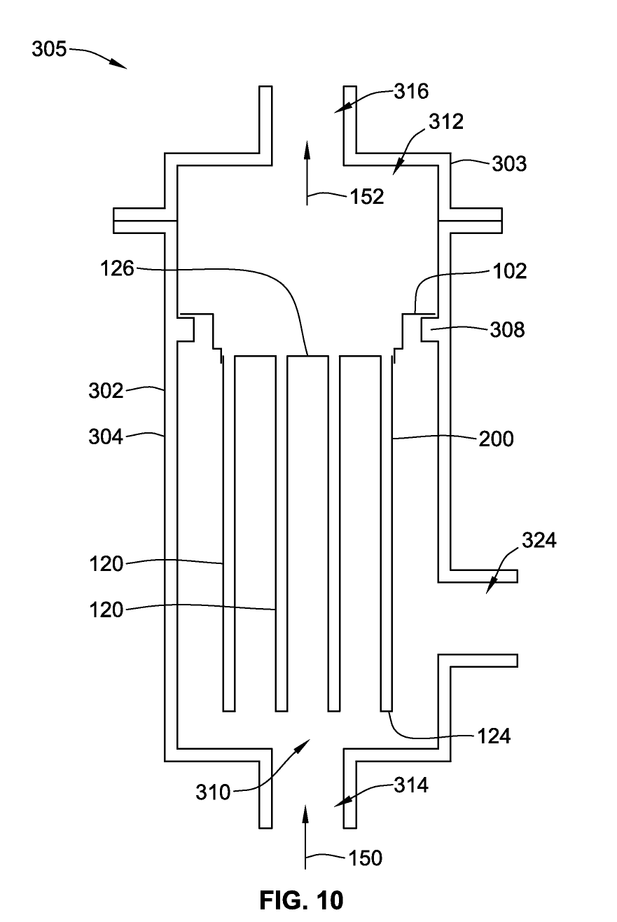

FIG. 10 shows a third exemplary embodiment of a filtration apparatus 300 configured for cross-flow filtration, shown as a cross-flow apparatus 305, where like numbers refer to like elements. In cross-flow filtration (also known as tangential flow filtration) a feed flow 150 of a contaminated fluid is passed tangentially across the concentric filter media tubes 116 of a filter, shown as an extended area filter basket 200, while a filtrate is filtered through the filter basket. Inlet plenum 310 of cross-flow filtration apparatus 305 is placed in fluid communication with a contaminated fluid inlet 314 and a retentate outlet 324. Outlet plenum 312 of cross-flow filtration apparatus 305 is placed in fluid communication with a filtrate outlet 316. As a contaminated fluid having an initial contaminant load flows into the inlet plenum, a portion of the fluid flows through filter 200 to outlet plenum 312 and to filtrate outlet 316 of cross-flow filtration apparatus 305. A portion of the contaminated fluid flows out of the inlet plenum 310 through the retentate outlet 324, carrying a higher contaminant load than the initial contaminant load. The flow of the contaminated fluid across the flow-in surfaces 120 of filter 200 continuously cleans particulate matter off of the flow-in surfaces 120, thereby extending the intervals between filter cleaning, replacement, and/or backwashing. Cross-flow filtration apparatus 305 may be optionally be a backwash system providing the capacity to backwash the filter basket 200.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter, comprising:
a plurality of sheets of metal filter media arranged in surrounding relation of a longitudinal axis, each filter media sheet extending between inlet and outlet faces of the filter, the inlet and outlet faces being at opposite axial ends of the filter;
a plurality of inlet passages being formed between the plurality of sheets of metal filter media, each inlet passage being open to the inlet face and closed to the outlet face and having a length extending generally in the direction of the longitudinal axis; and
a plurality of outlet passages being formed between the between the plurality of sheets of metal filter media, the outlet passages being open to the outlet face and closed to the inlet face and having a length extending generally in the direction of the longitudinal axis;
wherein a flow path from the inlet face to the outlet face passes through at least one of the sheets of filter media.

2. The filter of claim 1, wherein the sheets of metal filter media comprises wire mesh including a pore size of between 1 micron and 200 microns.

3. The filter of claim 2, wherein the sheets of metal filter media are self supporting, each sheet being spaced from and not in contact with another adjacent sheet of metal filter media in an intermediate region between opposed ends, supported between adjacent sheets of metal filter media being provided only at opposed ends proximate the inlet and outlet faces of the filter.

4. The filter of claim 1, wherein the sheets of metal filter media include a plurality of layers of metal filter material, wherein the flow path from the inlet face to the outlet face passes though at least two layers of metal filter material, the layers of metal filter material including a gradient porosity with an upstream layer and a downstream layer, the downstream layer having a smaller pore size than the upstream layer.

5. The filter of claim 2, wherein the sheets of metal filter media have a safe edge in the form of an annular metal strip extending longitudinally from the wire mesh, the wire mesh being welded to the annular metal strip, each sheet being wrapped into a tubular form with a longitudinal seam with opposed edges joined by a longitudinal weld.

6. The filter of claim 1, wherein the sheets of filter media include filter media selected from the group consisting of woven wire mesh, welded wire mesh, fiber-metal felt, sintered powder, wire wrap, wedge wire, sintered wire depth media, non-woven polymer, and woven polymer.

7. The filter of claim 1, further comprising a mounting ring in surrounding relation of the plurality of sheets of filter media, the mounting ring providing a seal for sealing against a housing, the mounting ring being welded to an outermost sheet of wire filter media.

8. The filter of claim 1, wherein the sheets of filter media are arranged in the form of annular tubes, with adjacent annular tubes being telescopically received in each other, and the filter further comprising a plurality of annular closures, the annular closures sealing between adjacent annular tubes to thereby provide for the inlet and outlet flow passages.

9. The filter of claim 8, wherein the annular tubes have a circular cross-section.

10. The filter of claim 1, the filter further comprising a plurality of annular spacer rings, at least one spacer ring forming an annular closure between each adjacent sheet to create at least one of the outlet and the inlet passages, the annular spacer rings being welded at inner peripheries and outer peripheries to adjacent sheets of metal filter media.

11. The filter of claim 1, wherein a first sheet of filter media is joined to a second sheet of filter media, forming an annular closure between the first sheet of filter media and the second sheet of filter media to create at least one of the outlet and the inlet passages.

12. An extended area filter, the filter comprising:
a first tubular sheet of metal filter media surrounding a longitudinally extending axis between opposed first and second end faces of the filter, the first and second end faces being at opposite axial ends of the filter with one of the faces being an inlet face and the other an outlet face;
a second tubular sheet of metal filter media telescopically interfit within the first tubular sheet of filter media;
a third tubular sheet of metal filter media telescopically interfit within the second tubular sheet of filter media;
a fourth tubular sheet of metal filter media telescopically interfit within the third tubular sheet of filter media;
a first annular closure between ends of the first and second tubular sheet proximate the first end face;
a second annular closure between ends of the second and third tubular sheet proximate the second end face; and
a third annular closure between ends of third and fourth tubular sheet proximate the first end face;
wherein first annular flow passages extending generally in the direction of the longitudinal axis are formed between the first and second tubular sheets and between the third and fourth tubular sheets, such that the first annular flow passages are open to the second flow face and are closed to the first flow face; and
wherein a second annular flow passage extending generally in the direction of the longitudinal axis is formed between the second and third tubular sheets, such that the second annular flow passage is open to the first flow face and closed to the second flow face, and wherein a flow path from the inlet face to the outlet face passes through at least one of the tubular sheets of metal filter media.

13. The filter of claim 12, wherein the sheets of metal filter media have a flow-in side and a flow-out side, and the flow-in sides of adjacent sheets of metal filter media are spaced at least 0.5 inches apart, and wherein the sheets of metal filter media have a pore size of between 1 micron and 200 microns.

14. The filter of claim 12, wherein the metal filter media is a surface filter metallic media.

15. The filter of claim 13, wherein the metal filter media is a diffusion bonded sintered laminate filter media.

16. The filter of claim 12, wherein the sheets of metal filter media have a safe edge in the form of an annular metal strip extending longitudinally from the wire mesh, the wire mesh being welded to the annular metal strip.

17. The filter of claim 12, further comprising a mounting ring in surrounding relation of the plurality of tubular sheets of filter media, the mounting ring providing a seal for sealing against a housing.

18. The filter of claim 12, wherein the annular closures include at least one spacer ring interfit between adjacent tubular sheets of filter media, each spacer ring being welded at an inner periphery and outer periphery to adjacent sheets of metal filter media.

19. A filter apparatus comprising:
a housing, the housing comprising an interior volume divided into an inlet plenum and an outlet plenum, and a filter holder, the filter holder separating the inlet plenum and outlet plenum;
a filter, the filter mounted in the filter holder, the filter comprising a longitudinal axis and inlet and outlet faces at opposite axial ends of the filter, the filter inlet face in fluid communication with the inlet plenum and the filter outlet face in fluid communication with the outlet plenum;
the filter further comprising a plurality of filter media tubes concentrically arranged about the longitudinal axis, each filter media tube extending between the inlet and outlet faces of the filter, wherein the filter tubes are configured to form a plurality of inlet passages between the plurality of filter tubes, each inlet passage open to fluid flow at the inlet face and closed to fluid flow at the outlet face, and having a length extending generally in the direction of the longitudinal axis; and
wherein a fluid flow path from the housing inlet plenum to the housing outlet plenum passes through at least one of the sheets of filter media.

20. The filter apparatus of claim 19, wherein the filter tubes are further configured to form a plurality of outlet passages between the plurality of filter tubes, each outlet passage open to fluid flow at the outlet face and closed to fluid flow at the inlet face, and having a length extending generally in the direction of the longitudinal axis.

21. The filter apparatus of claim 19, wherein the filter further comprises a mounting ring in surrounding relation of the plurality of the filter media tubes, the mounting ring providing a seal for sealing against the filter holder.

22. The filter apparatus of claim 19, wherein the filter media comprises at least one of a metal filter media,

23. The filter apparatus of claim 19, wherein the filter apparatus comprises a plurality of filters, each filter having an inlet face in fluid communication with the inlet plenum and an outlet face in fluid communication with the outlet plenum.

24. The filter apparatus of claim 19, wherein the filter apparatus is configured for down-hole filtration.

25. The filter apparatus of claim 19, wherein the filter apparatus further comprises an inlet pipe in fluid communication with the inlet plenum, an outlet pipe in fluid communication with the outlet plenum, and a drain valve in fluid communication with the inlet plenum.

26. The filter apparatus of claim 19, wherein the filter apparatus further comprises a second fluid inlet in fluid communication with the outlet plenum and a second fluid outlet in fluid communication with the inlet plenum, and wherein the second fluid inlet and the second fluid outlet are configured to define a cleaning fluid flow path from the second fluid inlet to the second fluid outlet, the cleaning fluid flow path passing through at least one of the sheets of filter media.

27. The filter apparatus of claim 19, wherein the filter apparatus further comprises an inlet pipe in fluid communication with the inlet plenum, and a filtrate outlet pipe in fluid communication with the outlet plenum, and wherein the filter apparatus is configured for in-line filtration.

28. The filter apparatus of claim 19, wherein the filter apparatus further comprises an inlet pipe in fluid communication with the inlet plenum and a retentate outlet pipe in fluid communication with the inlet plenum, and a filtrate outlet pipe in fluid communication with the outlet plenum, and wherein the filter apparatus is configured for cross-flow filtration.
